(19) United States
(12) Patent Application Publication
(10) Pub. No.: US 2017/0270267 A1
(43) Pub. Date: Sep. 21, 2017

(54) SYSTEM FOR MONITORING AND VALIDATING THE HYGIENIC TREATMENT OF MOBILE PATIENT SUPPORT DEVICES

(71) Applicant: CLINARIS Process Management GmbH, Kissing (DE)

(72) Inventors: Joachim MÜLLER-WENDE, Prittriching (DE); Stefan HERZOG, Dortmund (DE)

(21) Appl. No.: 15/504,729

(22) PCT Filed: Aug. 18, 2015
(86) PCT No.: PCT/EP2015/068965

§ 371 Date: Feb. 17, 2017

(30) Foreign Application Priority Data
Aug. 18, 2014 (DE) 10 2014 111 778.6

(51) Int. Cl. G06F 19/00; G06Q 10/10

(52) U.S. Cl. CPC G06F 19/3418; G06F 19/325; G06Q 10/109

(57) ABSTRACT

The invention concerns a method for monitoring the treatment of mobile patient support devices. The infection status of a mobile patient support device is registered in a database in a computer system. The mobile patient support device is identified at a treatment station using a data reader which identifies an identification tag attached to the mobile patient support device. Information on the infection status of the mobile patient support device is output at the treatment station.

### CROSS-REFERENCE TO RELATED APPLICATIONS

This application is a U.S. National Stage application of PCT/EP2015/068965 filed Aug. 18, 2015, which claims priority to German Application No. 10 2014 111 778.6 filed Aug. 18, 2014, the entire disclosures of which are hereby incorporated by reference in their entireties.

### TECHNICAL FIELD

The invention relates to a method for monitoring the treatment of mobile patient support devices, for example, beds, stretchers, lifters, wheelchairs and wheeled walkers for use in clinical situations such as hospitals, acute clinical departments, rehabilitation facilities, care homes and other establishments where enhanced hygiene is necessary and treatment, i.e. cleaning and disinfecting, of mobile patient support devices is legally required.

### BACKGROUND

Beds are used for different purposes in clinical situations. Whereas a bed for history taking and diagnosis of a patient often has the form of a couch, is used only briefly and that often only a little cleaning or the changing of the paper covering is required between patients, for prolonged or long-term admission and/or treatment of a patient, beds are needed which are legally defined as medical products and therefore are subject to high and strict hygiene standards which are regulated by law.

The large number of existing beds and the high turnover rate of these beds in healthcare institutions result in elevated complexity in the administrative and treatment processes for these beds. In addition, beds are used by a wide range of patients with differing disease profiles and infection risks.

In the clinical domain, beds can be divided into three categories which define an infection status of the bed: 1. “Clean bed”, i.e. disinfected and treated in accordance with the current regulations and available for re-use by a new patient—2. “Unclean bed”, i.e. following use by a patient without infection risk, awaiting disinfection and treatment—and 3. “Infected bed”, i.e. following use by a patient with an identified infection and thus a raised infection risk for the next patient, for personnel of the medical establishment and visitors, awaiting disinfection and treatment.

Particularly “infected patients” who can transmit potential pathogens represent a high infection risk to other patients, clinical personnel and visitors. Therefore, each bed which can be classified as an “infected bed” should be identifiable. Infected beds should be clearly and unmistakeably identifiable in order to initiate suitable safety measures and so that a prescribed treatment process adapted to the high risk level can be carried out, including starting suitable occupational safety measures for the personnel.

Careful handling of such potentially infected beds has a very great clinical relevance. In Germany, more than five percent of patients develop a hospital-associated infection and worldwide the average is over ten percent. Among the best known pathogens are, for example Pseudomonas aeruginosa, Clostridium difficile and Staphylococcus aureus. These microbes are however often to be eliminated by means of correct disinfection of all objects with which the affected patient has been in contact, and thus the associated risks of transmission are also contained. Due to the intensive and long-lasting contact with the patient, the bed therefore has a great significance.

For the efficient, effective and ultimately safe treatment of clinical beds, in Germany and many other countries there are legal regulations which determine the type, scope and use of disinfectants and the time of exposure before re-use for the next patient.

If these regulations are not, or are incompletely or incorrectly, carried out, this can therefore result in a much greater health risk for patients, clinical personnel and visitors if these pathogens are transmitted, for example, by contact with the contaminated bed and/or even develop a resistance, through transmission and mutation, against conventional antimicrobial, antimycotic or antiviral agents. Probably the best known hospital-associated infection results from such a mutation of Staphylococcus aureus following formation of a resistance to methicillin (MRSA). Throughout Germany, the annual number of microbial infections in hospitals is estimated to be over 500,000. In the field of inpatient care, it has also been shown that 20 percent of the clinical Staphylococcus aureus infections include MRSA. Other diseases which are transmissible, for example, by means of bodily fluids such as, for example, Herpes simplex virus (HSV), through blood, for example, human immunodeficiency virus (HIV), through skin contact, for example, human papilloma viruses (HPV), by ingestion, for example, norovirus or by aerogenic transmission, for example, Influenza viruses or Ebola naturally also require a specific disinfecting method to minimise the transmission risk. Faulty steps in the treatment process for a potentially infected bed can thus have serious consequences for patients, clinical personnel and visitors.

The increased incidence of illnesses due to hospital-associated infection leads to a prolongation of the stay of a patient, a reduction in quality of life and a substantial increase in the costs to the healthcare system; the availability of hospital beds and medical care facilities is thus also negatively influenced. Not least, this leads to a heightened risk for the respective medical establishment of compensation claims by affected patients/clinical personnel/visitors. In addition, the reputation of the clinical establishment in question suffers.

Depending on the circumstances of the hospital concerned or the circumstances of the administration, the nursing management and the housekeeping, unclean hospital beds are collected in rooms provided for the purpose either decentrally (on the ward) or centrally (the bed store) in order that the treatment/disinfection will be carried out at a later time. Often unclean beds remain in the ward in question or are “parked” in passageways or other freely accessible areas of the hospital until their transportation to the treatment area. It is herein clear that all unclean beds and particularly infected beds must be lastingly and unmistakeably identified. The lack of an unambiguous identification marker of an unclean and, in particular, an infected bed can lead thereto that infected beds are stored mixed together with normal soiled beds in one room. The resultant risk arises that infected beds are not recognised and are not made “harmless” with the disinfectants designated for infected beds. If, in addition, the type of the infection risk/the type of pathogen is unknown, then the bed treatment department also cannot set the required time of exposure of the respective designated disinfectant that is required so that the respective microbes can be completely killed. Infected beds can thus preferably also be identified according to the type of infection risk/pathogen so that in the treatment process both the disinfectant and also the time of exposure can be adhered to accordingly. If the type of infection risk is not stated, then the treatment process should always be based on the “worst case” as standard, i.e. the highest level of risk should be assumed.

An identification of unclean beds as infected beds and the type of pathogen should take place no later than when the bed is fetched from a ward, in order to be able to initiate the correct, legally prescribed treatment process and the relevant occupational safety measures; for example, the packaging of the bedding into suitable plastic sacks, the visual identification of the bed as a potential risk to its surroundings, the putting on of personal protective equipment. These measures contribute thereto that the working safety of the staff is improved, while simultaneously reducing the risk of a spread of the pathogen and the endangering of further patients.

Computer-assisted systems for bed management and thus for recording and amending a bed status between, for example, “free”, “occupied” or “to be collected” are known. There is, however, no method which, during the logging of a bed, simultaneously also records and documents its infection status and thus initiates a treatment process that is suitable and prescribed for this infection status. Currently, this is carried out very primitively through the provision of an infected bed with a docket, or orally on demand. This method does not solve the above mentioned problems and does not permit the establishment of resilient hygiene standards, because it is not testable and because, for example, the status is not recorded systematically, the status can become lost in the process or is no longer accessible and/or the status gives no notification of safety and treatment measures associated with the status. Thus, the medical establishment has no possibility for providing reliable evidence of, for example, which bed was an infected bed at which time point and which specific safety measures have been undertaken or whether and which possible risk for patients, personnel and visitors has been incurred.

It is therefore an object of the present invention to provide a method which solves the above-mentioned problems and monitors the treatment process and makes it validatable—specifically overall as well as in individual steps—in order to ensure the legally required safety and hygiene standards, but also the respectively applicable industrial safety requirements.

### SUMMARY

This object is solved by means of a method according to independent claim 1 and a system according to claim 16. Advantageous developments are contained in the respective dependent claims.

The solutions described below should not be read as relating exclusively to beds, rather they relate in general to every type of mobile patient support device, for example, also (mechanical) couches, stretchers, wheelchairs, rollators, lifters, chairs, operating tables, walking aids, shelves or other mechanical elements which can support a patient and can thus come into contact with him.

The invention provides a method for monitoring the treatment of mobile patient support devices. Initially, the infection status of a mobile patient support device used by the patient is recorded in a database of a computer system. This mobile patient support device can also be identified at a treatment station through the identification of an identification indicator applied to the mobile patient support device by a data reader. At the treatment station, a notification can then be output concerning the infection status of the mobile patient support device.

The infection status can be, for example, “clean”, “normal unclean” or “infected patient support device”. It is also possible, particularly in the case of the “infected patient support device” to undertake a more precise specification of, for example, the type of the pathogen.

A treatment which can subsequently take place and is required by law on a change from one patient to the next is directed to the degree of contamination and potential infection risk. The strength of the effects and the time of exposure to the disinfectant agent are to be selected depending upon the infection status. Lists of disinfectant agents, the RKI and VAH lists, prescribed by the legislature serve as an aid during the selection and use of the suitable disinfectant agent. The treatment process always contains the substeps of cleaning and disinfection of the mobile patient support device.

Such an inventive monitoring system offers the advantage, inter alia, that the person responsible for the treatment always receives a notification of the infection status of the patient support device. Thus, firstly, the safety of this person is ensured since he can protect himself according to the infection status, for example, by putting on protective clothing (PPE, personal protective equipment) and, secondly, the observance of the legally prescribed treatment is initiated in order to prevent the spread of potential pathogens.

In a preferred embodiment, the infection status is recorded with a data reader, wherein the recording takes place by means of identifying an identification indicator applied to the mobile patient support device with the data reader. Either the infection status is automatically recorded in the database by means of the identification, or the infection status is input manually before or after the identification. The type of the infection risk can be input manually into the database subsequently.

The recording of the infection status can take place, for example, by means of the physician responsible for the treatment, the nurses and/or the treatment personnel, wherein the respective person can also have a further identification indicator him/herself. Thus, the identification of a personal identification indicator before or after the recording of the infection status can also comprise proof of the decision of the respective responsible physician, the responsible nurse and/or the responsible treatment personnel.

Particularly preferably, the recording of the infection status also leads, for example, to an automatic notification for collecting and/or treating the mobile patient support device, for example, to the collection and delivery service or the treatment personnel.

An embodiment in which the recording of the infection status takes place automatically with the data reader offers the advantage that, in contrast to a manual input, the acquisition takes place with a single simple step of identification and is accordingly less fault-prone. At the same time, in a further preferred embodiment, a bundle of data/information relating to the mobile patient support device can be generated and stored, for example, in the database, such as performing personnel, location of the mobile patient support device, time and action and treatment step carried out. Thus, for example, a physician, a nurse and/or the treatment personnel can with a data reader in the form of a scanning device, with one action record both the infection status of the mobile patient support device and also initiate a notification regarding the collection and/or treatment.

If the recording of the infection status does not take place with a data reader, the infection status can be acquired by means of a manual input, possibly after inquiry and/or retrospectively. It is herein particularly preferred that the infection status of the mobile patient support device, where this involves an infected bed/an infected patient support device, can be changed only after completion of the treatment. This has the advantage that an inadvertent interim identification of the identification indicator of the mobile patient support device and/or an omission of necessary treatment steps does not lead to a change in the infection status of the mobile patient support device and it is not unintentionally made available for renewed use by a new patient.

In a further preferred embodiment, the mobile patient support device has at least two identification indicators which are assigned to different infection status levels, for example, “normal unclean” and “infected patient support device”. The data reader identifies one of the at least two identification indicators, specifically that which is assigned to the existing infection status. The infection status of the mobile patient support device can thus be acquired in the database of the computer system by identifying the corresponding identification indicator with the data reader, that is for example, for a normal contaminated mobile patient support device, the first identification indicator, and for a mobile patient support device at risk of infection, the second identification indicator.

Particularly preferably, the different identification indicators are further configured to show the infection status visually. For this, these are configured, for example, in different colours, have a different pattern or are applied to a part of the mobile patient support device that identifies for the infection status.

An embodiment which has different identification indicators has, inter alia, the advantage that it is possible to differentiate between the different contamination and/or infection levels on acquisition of the infection status. In particular, 3, 4, 5 or more different identification indicators can be provided for respective corresponding infection statuses. Furthermore, a visual design offers, inter alia, the advantage that an inadvertent identification of the wrong identification indicator is prevented.

Particularly preferred therein is an embodiment wherein an infection status of the mobile patient support device, once recorded, is called up regardless of which identification indicator applied to the mobile patient support device is identified at a later time point.

The identification of one of the identification indicators of the mobile patient support device should, for example, always call up the recorded infection status of the mobile patient support device at a treatment station as information for the responsible treatment personnel. This has the advantage, inter alia, that no doubt arises regarding the infection status, and this is not influenced by a further identification of one of the identification indicators of the mobile patient support device and furthermore, time is saved on acceptance at a treatment station, since the right identification indicator of the mobile patient support device matching the acquired infection status does not have to be searched for.

Also preferred is an embodiment wherein an infection status of the mobile patient support device, once recorded, can be amended from “normal unclean” to “infection”, but not vice versa, specifically independently of which identification indicator applied to the mobile patient support device is identified at a later time point.

In the event that a mobile patient support device is to be identified subsequently at a treatment station as an infected patient support device, the responsible physician, the responsible nurse and/or the responsible treatment personnel can manually correct the infection status in the system, for example, from “normal unclean” to “infected”.

For the treatment, a relocation of the mobile patient support device into a treatment station is often provided. The relocation is often carried out by a person responsible for the collection and/or treatment of the mobile patient support device, for example, cleaning personnel or personnel of the internal collection and delivery service of the establishment, who can also have a personal identification indicator. Thus, the personal identification indicator can be identified in order to confirm and register the collection and/or treatment by the respective person. This has the advantage, inter alia, that for example, the responsible person can be asked regarding the momentary status of the treatment or storage and/or in case of any problems or doubts regarding the mobile patient support device after completed treatment, the person responsible for the treatment can be identified and asked. It can thereby also easily be determined subsequently which persons have had contact with the patient support device in question. This can be particularly important if it becomes clear subsequently that the infection level of the patient support device has been set too low since, for example, multiresistant microbes have been identified in the environs of the patient support device.

The identification of the identification indicator can take place by means of radio and/or optically. In a preferred embodiment, the identification indicator is identified with a data reader such as, for example, a mobile scanning device. In a particularly preferred embodiment, the identification indicator is a bar code and the data reader is accordingly a bar code reader. Radio systems, for example RFID, can also be used. In a further preferred embodiment, the data reader is a mobile hand-holdable wireless and/or battery/accumulator powered device which can acquire data by means of radio or a fixed connection or other transmission techniques, transfer it to the computer system and/or call it up therefrom when the identification indicator is identified. Thus, for example, the data reader can also be a mobile telephone, smartphone or PDA.

The use of a mobile, hand-holdable wireless and/or battery powered data reader has, inter alia, the advantage that such a data reader is usable, for example on a hospital ward for a plurality of rooms and can be used by different persons as required. Through the disappearance of manual, fault-prone input and instead the use of an automatic transfer and/or output of a notification, errors are largely prevented and the hygienic safety and industrial safety is ensured. The automatic transfer of data between the data reader and the central computer system or the database can take place both immediately and temporally delayed.

Further, due to the identification of an identification indicator applied to the mobile patient support device, a verifiable registration can take place which can also comprise the registration of substeps of the treatment process which is particularly advantageous for both the administration from an organisational viewpoint and also with regard to legally prescribed hygiene measures. It is also, inter alia, advantageous that a data set with a notification of the infection status can be generated which, possibly in a graphical, optical, acoustic or other form, can give specific instructions in order further to ensure safety.

In a further preferred embodiment, the location of the mobile patient support device can also be recorded in the database, for example, the room, the position of the bed in the room, the ward or the collection point where the mobile patient support device is situated. Particularly preferably, the recording of the location is undertaken by identification with the data reader of an identification indicator applied at the site or close to the site. This can be, for example, a bar code mounted in a room which identifies the room in which the mobile patient support device stands or the location in the room. Scanning of such a barcode before or after the identification of the mobile patient support device thus records the location of the mobile patient support device in a database of a computer system in order, for example, to enable the localisation of the mobile patient support device. The location is thus not necessarily a resting location for the patient, but can also be, for example, a medical procedure room, a treatment room, cleaning room, storage room, labour ward or a “traffic area”, for example, parking positions in corridors. Thus, not only the infection status, but also the location of the mobile patient support device can be tracked.

In a preferred embodiment, the notification regarding the infection status of the mobile patient support device which is output following the identification of the mobile patient support device at the treatment station can comprise an acoustic, visual, audiovisual and/or mechanical signal. A visual signal can be, for example, a graphical representation on the data reader. Alternatively or additionally, the identification brings about the generation of a data set on the data reader.

Particularly preferably, the notification is the output of a light and/or a sound by means of a suitable device. For example, a light combination can be used in which, for example, a green light or the absence of a light indicates no infection risk and a red light indicates an infection risk. The frequency at which the light is switched on and off can indicate, for example, the infection level. Furthermore, the sound can take the form, for example, of a buzzing in order to indicate an infection risk.

A mechanical signal could take place, for example, by means of a vibration of the data reader, although it can also take the form of a movement and/or raising of an object. The mechanical signal can also result in a release of a restriction, locking or other blocking. This can be, for example an automatic opening of a lock on a room door, cabinet door, a cabinet and/or a cabinet compartment or a drawer. By this means, access can be granted for the cleaning personnel to suitable cleaning and/or protective means. If, for example, by means of such a mechanical notification, a personal protective equipment is made available, the cleaning personnel recognises that it is necessary, due to the infection status of the patient support device, to use this protective equipment. Similarly, for example, it can be ensured by making particular cleaning and/or disinfection materials available that means are used which are suitable and/or prescribed for the infection status of the patient support device.

Furthermore, the mechanical signal can also restrict the mobility of the mobile patient support device, for example, by the activation of a braking system for the mobile patient support device or the regulation of a barrier, sliding doors and/or gate in order to prevent access to another step of the treatment.

Particularly preferably, the notification comprises a plurality of components which can be, respectively, an acoustic, visual, audiovisual and/or mechanical signal. Such a multi-part notification can also accompany the treatment personnel through individual steps in the treatment process and thereby ensure the correct execution of the treatment process.

The output of a notification concerning the infection status always takes place automatically, i.e. without human interaction. The device which outputs the notification is connected for this purpose, for example, via cable or radio to the computer system and in this way receives information that a notification or which notification is to be output. The notification device itself can comprise a computer or it can be controlled from the central computer system.

Particularly in the cases when the notification is mechanical in nature, no human interaction is needed, so that possible error sources are eliminated. If the notification comprises, for example, the opening of a cabinet door or drawer, the opening of the cabinet door or drawer can be carried out by means of a motor that is controlled by the central computer system or by a separate notification device. If the notification comprises, for example, the release of a cabinet door or drawer, so that only this can subsequently be opened by the personnel, whilst other cabinet doors or drawers remain closed, the release of the cabinet door, the drawer and/or the cabinet can be carried out by means of a lock which is activated by a motor or an electromagnet and which is controlled by the central computer system or by a separate notification device. The release can also take place by means of an unlocking of a pre-tensioned spring in that, for example, a weight results in a movement of this locking mechanism and the pre-tensioned spring results, by its extension, for example, in the opening of a cabinet.

The release or restriction can further also take place pneumatically or hydraulically and can additionally be initiated, influenced or prevented by an optical device (such as a photoelectric barrier). Thus, for example, the displacement of a weight, for example, by the placement of an object or a person at a pre-determined place can be perceived by a movement sensor, which causes a hydraulic device to release a locking and/or blocking, for example, by means of a collapsing of a telescopic rod. The displacement can also result in a lowering or raising of a pedestal or platform or a floor plate which can be perceived by a corresponding change of an optical reference signal by means of a sensor and releases a locking. Furthermore, a weight sensor can also initiate this.

A restriction of the mobility of the mobile patient support device can also take place, for example, by means of a barrier in the room or a braking system in the room and/or on the patient support device. For example, a hydraulic or pneumatic device, for example, the pushing apart of a telescopic rod and/or the movement up or down of a barrier, for example, out of the floor or out of the ceiling, can restrict the mobility of the mobile patient support device. By this means, it can be ensured, for example, that a patient support device remains at a particular place until all or pre-determined treatment steps have been carried out.

An indication regarding the infection status of the mobile patient support device has, inter alia, the advantage that a defined treatment process is instigated and this requires no substantial consideration by the personnel. Furthermore, a restriction or release as described above can prevent an inadvertent skipping of treatment steps and a treatment is enforced that is prescribed and is often legally required in its type and duration, e.g. the time of exposure to the disinfectant before the release of the mobile patient support device.

In a preferred embodiment, the output of the notification regarding the infection status can also comprise the provision of at least one safety measure. Also to be considered herein is the preparation of personal protective equipment such as gloves, protective goggles, hood, mouth protection, overshoes, tunic, safety suit and/or visor. It is thus directly apparent to the personnel that the mobile patient support device has a particular infection status and which protective apparatus is required for the treatment. The provision of the protective equipment depending upon the infection status can take place as described above by opening or unlocking a cabinet, cabinet compartment, a drawer or another storage device.

Furthermore, the provision of, for example, special cleaning, disinfection or protective materials which enable the elimination of potential pathogens or offer protection during relocation or during the treatment process of the mobile patient support device, is to be considered in order to prevent the spread of potential pathogens. The provision of cleaning, disinfection, covering, isolation or sterilisation materials or protective foils should herein be considered in order to enable the isolation of such potential pathogens. The provision of these materials can take place as described for the provision of protective equipment.

The instigation of a safety measure has the advantage, inter alia, that mandatory steps are also instigated by it, in order to allow safety and hygiene without extensive consideration by the personnel, which ultimately leads to the prevention of an error-prone treatment of the mobile patient support device

The provision of a safety measure can also take place automatically and/or following identification of a further identification indicator. This can result, for example, in the opening of a particular part of a cabinet only after scanning of a barcode applied to a cabinet, in order to provide the necessary safety measure. In the event of a preferred automatic provision, a scanning of such a barcode applied to the cabinet part can also bring about a registration in the database of a computer system. In addition, the respectively provided materials can also have an identification indicator which can be identified with the data reader, which also brings about the registration of the respective use of the material. Further particularly preferred is a restriction of the mobility of the mobile patient support device until, for example, the necessary safety measures have been prepared or carried out and/or registered as such in the database. Only thereafter can a release of the mobile patient support device take place.

In a further preferred embodiment, the method can have successive steps in the treatment process wherein the execution of the steps is registered with a data reader. The registration of the steps can be recorded, in each case, in the database and thus documented.

Such an inventive monitoring of the treatment steps offers, inter alia, the advantage that the person responsible for the treatment can always receive a notification regarding the infection status of the patient support device and/or on the step to be performed in the context of the treatment process. Thus, firstly, the safety of this person is ensured since he can protect himself according to the infection status, for example, by putting on protective clothing (PPE) and, secondly, the observance of the legally prescribed treatment is ensured in that the system guides the personnel through the individual steps of the treatment with the aid of a database.

In a particularly preferred embodiment, the treatment process has specifications which can comprise the following steps, for example, for mobile patient support devices such as beds:
a. The treatment typically takes place in the central bed store, which has a strict separation between “clean” and “unclean” regions, which are also clearly visually identified.
b. The unclean bed arrives in the central bed store covered with a protective plastic foil.
c. Initially, the unclean bedding is taken off and collected separately. Bedding from infected beds is separately packaged/sealed in plastic sacks and identified accordingly as infected laundry.
d. The unclean bed equipped with a mattress, emergency evacuation sheet (between mattress and bed) and with overbed lifting pole awaits treatment in the unclean room.
e. The treatment personnel put on the prescribed personal protective equipment. Depending on the level of contamination and infection, this includes gloves, mouth protection, head covering, protective goggles, hood, apron, protective suit/overalls, shoe covers. The relevant personal protective equipment is specified as mandatory.
f. The treatment personnel ensure that the disinfectant to be used is available (either ready mixed in the case of a standard disinfection, or in the case of an infected bed, according to the present infection, a solution to be freshly prepared). Typically, solutions to be used for the infected bed disinfection have an expiry date, i.e. the recording of the time and date of preparation is mandatory, so that an ineffective, that is, already expired disinfectant solution is not inadvertently used at a later time point.
g. For the treatment, mattress, evacuation sheet and lifting pole are separated from the bed, initially cleaned (if severely soiled) and then separately treated by wiping disinfection with a prescribed disinfectant (from RKI or VAH lists).
h. The bed itself is initially cleaned (if severely soiled) and then separately treated by wiping disinfection with a prescribed disinfectant (from RKI or VAH lists). During wiping disinfection, care should be taken to ensure that tissues/cloths used are each only to be dipped in the disinfectant solution once before contact with the bed. It is mandatory to use a new cloth each time.
i. If a washing tunnel is available, then the objects defined under (g) and (h) are treated by machine. The machine treatment is not used for infected beds since an exchange of the disinfectant and subsequent cleaning of the equipment would be too time-consuming and thus too expensive. Furthermore, in the case of an infected bed, the substantially more thorough wiping disinfection by hand is preferable.
j. Once all the surfaces of the bed, the mattress, the evacuation sheet, the lifting pole have been treated with the relevant disinfectant, complete drying of the disinfectant must next be awaited before a “reassembly”/a “re-equipping” and a reuse can take place at all (MPG-BetreibVO—German regulations on the use of medical products). The drying typically takes place in the “clean” area. The minimum duration of the exposure time is legally defined for each disinfectant and each pathogen/the respective infection and absolutely must be complied with so that the individual parts are completely dried before the reassembly and the permissible re-use. Only a completely dried medical product, and thus a mobile patient support device, may be brought back into use.
k. The bed is now situated in the “clean” area. It should be noted (and documented) here that either separate personnel are deployed who have had no contact with the “unclean” area or the treating personnel removes the (now contaminated) personal protective equipment and undertakes a hand disinfection before touching the treated objects. This is absolutely necessary since the gloves worn during the treatment are either contaminated or, due to the wearing of the gloves and the moist environment arising therein, the just treated bed is subject to a contamination risk.
l. Thereafter, the reassembly of the objects and subsequently the equipping of the bed with “clean” bedding takes place.
m. Subsequently, the bed is covered with a plastics protective foil for protection against renewed contamination on the transport route and the parking positions provided therefor before the next patient may use the bed.

In order to enable the registration of the individual steps, additional identification indicators can be applied to the mobile patient support device or the environs of the bed treatment area.

The monitoring and control of the above described treatment process can however also comprise only selected individual steps and/or other treatment steps not described above.

Preferably, each step of a treatment process is listed on a chart or a display on a wall and apart from a description, is also denoted with an identification indicator, for example barcodes, which can be identified by means of a data reader and correspondingly registered in the database of the computer system.

Furthermore, the person involved in the treatment process can also be registered. This person, for example, a person of the cleaning or bed personnel has a personal identification indicator. For example, the personal identification indicator can also be a barcode and the person can identify the barcode with a data reader either before or after the respective step. The registration of the steps carried out thus additionally provides proof of who was responsible for the respective treatment steps and has carried them out at which time point. In order to restrict the number of necessary actions for the identification, a combination between identification indicator and the data reader can also be radio-based, for example RFID.

The registration and monitoring of all these steps accordingly leads to increased safety and a great reduction in the risk of incomplete, faulty, non-regulation or non-executed treatment. Thus not only are infection risks to personnel and patients controlled, but these steps also lead to a mandatory sequence which conforms to the law and can be proved through the registration. With this proof possibility, damage is reduced and liability risks are reduced, which can have a favourable influence on the insurance premiums of, for example, the respective hospitals.

In a preferred embodiment, it can also be provided that an infection status can only be amended at the end of a successfully completed and registered/documented treatment process into a status which has no further infection risks. This leads to a further increase in the safety of the treatment process. Herein, for example, following completion and registration of all the steps provided for an infection level, the status of the mobile patient support device is automatically amended to a status which enables the release and/or re-use of this mobile patient support device. Particularly preferably herein the momentary status of the treatment process on calling up the status of the mobile patient support device is displayed until the treatment process is completed.

In a further preferred embodiment, the passage of time of the steps of the treatment process is monitored and a notification is output at least at a predetermined time during at least one of the steps of the treatment process. As described above, the notification can comprise an acoustic, visual, audiovisual and/or mechanical signal. Thus, the notification can be, for example, a light which is switched on for a pre-determined time or has a colour until the pre-determined time and after the pre-determined time has another colour which remains switched on until the next step is registered. The pre-determined time data are stored in the computer system.

An embodiment with a monitoring of the passage of time has the advantage, inter alia, that times of exposure to cleaning and disinfectant materials are adhered to and a complete treatment with complete elimination of the potential pathogens is ensured. The output of a notification during the time provided leads to an improvement of the treatment standard in that the personnel proceeds following a notification which automatically compares the time provided with the passage of time and thus the personnel is enabled to carry out immediate self-monitoring.

Particularly preferred therein is an embodiment in which following the registration of a step of the treatment process, a timer is started, wherein during a registration of a further step of the treatment process before the expiry of the timer, a warning system is caused to output a warning notification. This leads to a monitoring of the treatment process and enables the immediate correction of an erroneous step in the treatment process. This could be, for example, a warning light or an alarm which is switched on if the pre-determined time of the step which is monitored by the timer, determined for example by the time of exposure of a disinfectant, has not yet expired and a following step has already been registered. The temporal limitation of the respective steps therefore supports the monitoring of the treatment, wherein the times stored are target times.

In a further preferred embodiment, the registration of the steps of the treatment process in a sequence which deviates from a pre-determined sequence can prompt a warning system to output a warning notification. The steps of a treatment process described above provide, for example, that the equipping of a mobile patient support device with clean bedding takes place after wiping disinfection with a prescribed disinfectant. Such an embodiment offers inter alia the advantage that if the equipping unintentionally takes place before this wiping disinfection, a warning notification in the form, for example, of an alarm is accordingly output in order to prevent this and to be able to prevent a faulty action specifically in that the mobile patient support device can be handed over for treatment again, as can the associated bedding.

In a further preferred embodiment, a warning notification can also comprise a restriction or release of the provision of a safety measure or a restriction of the mobility of the mobile patient support device. If, for example, a second registration takes place before the pre-determined time of a treatment step or a registration of the steps deviates from a pre-determined sequence, it can be provided that, for example, a braking system, a barrier, a sliding door and/or a gate inhibits the relocation of the mobile patient support device in order to prevent access to another step of the treatment. For example, this can also result in a restriction, locking or other blocking. This can hinder, for example an opening of a lock on a cabinet door, a cabinet and/or a cabinet compartment or a drawer in order, for example, to prevent the provision of new equipment. Naturally, this can also initiate the provision of additional safety measures by an automatic release of, for example, disinfectants and/or personal protective equipment.

The registration of all treatment steps and, if relevant, also the registration of the materials used and the registration of a person and/or the location takes place automatically in all cases. For example, following the recording of the infection status in a database of a computer system, it is provided by means of a logic stored in the computer system that for each step, the identification of a corresponding identification indicator leads to an updating of the database and the step is thus registered therein. The logic can also provide that an identification of a personal identification indicator, a means used and/or a location is assigned to this step and is thus automatically registered. If, for example, the identification of a personal identification indicator for a first step is forgotten and a second step is already registered, the logic can also provide that an identification of the personal identification indicator following the second step also leads to a registration of the person for the first step and automatically updates the database for the first step.

If, for example, an identification of an identification indicator for a means to be used for the first step does not take place before the registration of the second step, the same logic can provide that a warning notification is output and/or the first step must necessarily take place again.

The present invention also includes that the control and/or monitoring of the treatment process can take place independently of the recording of the infection status and/or independently of the identification of the patient support device in that, for example, a desired and necessary treatment process is selected for a patient support device, for example, at the treatment station. For example, the treatment personnel, if for example, the infection status of the mobile patient support device is not known or an infection status entered in the system is not present or callable, can select a treatment process for an infected mobile patient support device. Following input of an identification indicator of the mobile patient support device, the treatment process is started automatically and the treatment personnel is guided through the selected treatment process by means of the above described notifications. It is also possible to select a treatment process which is subsequently monitored/controlled when the patient support device is provided with a notification regarding the infection level, for example, with a note as is still often the case currently. The monitoring and safety of the treatment process is thus ensured in these cases also.

The monitoring of the treatment by registration of the individual steps of the treatment and the initiation of notifications regarding the infection status of a mobile patient support device offer an additional protection for both the patients and the personnel in the healthcare system. Potential spread of a pathogen is greatly minimised by the mandatory monitoring of the execution of the treatment steps. The infection status of a mobile patient support device can also be determined before the patient leaves it, for example, when the status of the patient forms a hygiene or infection risk. In such a case, the recording of the infection status in the database can take place manually on a ward or by identifying the identification indicator. An automatic notification for collection and/or treatment accordingly does not take place in the same step, but can be initiated, for example, by means of a second identification, specifically after the patient has finally left the bed.

The monitoring preferably takes place by means of the identification of identification indicators with a mobile data reader. A continuous updating of the database in a computer system further enables an increase in the efficiency in that the recording of the infection status can initiate the output of a notification in the form of a communication to collect and treat the mobile patient support device. A registration of the location also enables the direct localisation of the mobile patient support device in order to shorten further the time needed for the transport and the treatment. On identification of the mobile patient support device by means of a mobile data reader at a treatment station, a notification is thereby output concerning the infection status. Thus, mandatory steps of the treatment process are followed and a correct treatment is also provided by the provision of safety measures and/or warning notifications.

The registration of all steps enables not only the monitoring of the treatment, but also enables the optimisation of these processes in that a system analysis can illustrate the scope of the erroneous steps and can analyze, where possible errors are made, for example, process steps are omitted, if defined target times are overshot or undershot, how many unclean mobile patient support devices are situated where in the medical establishment, on which wards the greatest infection risks occur and what steps should take place quicker or be optimised.

The method for monitoring the treatment can simply be implemented in existing systems and is also adaptable to existing or future systems. Thus, the infection status of the mobile patient support device can be linked, for example, directly to a patient status. If it is known about a patient that he is infected or has potentially been infected and thus poses an infection risk to other persons, then such an infection status of the patient can be stored in a database of a computer system. Such an infection status of the patient has the result that a mobile patient support device used for this patient also constitutes a potential infection risk. The infection status of this mobile patient support device is thus automatically linked to the infection status of the patient.

Furthermore, it can be provided in the method that, for example, following the entry of a discharge of a patient in a database of the computer system, apart from the infection status of the mobile patient support device, a communication for collection and/or treatment of the mobile patient support device is automatically initiated.

An identification of the identification indicator of the mobile patient support device by a person responsible for the collection and/or treatment of the mobile patient support device can also, as described above, initiate a notification concerning the infection status of the mobile patient support device by means of a provided linkage of the mobile patient support device to the infection status of the patient.

This has the advantage, inter alia, that both the recording of the infection status of the mobile patient support device and also the initiation of a communication for collection and/or treatment of the mobile patient support device takes place automatically after the discharging of the patient. This reduces the number of necessary actions for the monitoring of the treatment.

Furthermore, in the method, the registration of the respective persons, mobile patient support devices, locations, wards and actions can be combined in a database.

Thus, not only can a room allocation take place dependent upon the infection status and the number of mobile patient support devices, but threshold values, for example, for the number of existing and/or collected unclean mobile patient support devices and/or the number of the personnel available for the start of the treatment can also be provided, in order further to increase the efficiency of the treatment. The automatic room allocation can also provide that mobile patient support devices are only stored at the location provided. If a mobile patient support device is placed at an incorrect location, following suitable registration, the method can further output a warning notification.

A system which monitors, for example, the usage or issuing of materials, for example with a sensor and detector, can be implemented in the method with comparable identification indicators as described above. Thus, for example, a dispenser for fluids, for example, disinfectant or cleaning fluid, or for example, cleaning cloths or laundry can comprise a movement sensor and/or a weight sensor which can check the usage and, can further also have an identification indicator, for example, a barcode. An identification of such a barcode before the actuation of a dispenser has the result that following the actuation of the dispenser, a sensor confirms the usage and a further registration of the usage takes place in the database of a computer system. This has the advantage, inter alia, that, for example, the use of disinfection materials that are provided and mandatorily prescribed can be proved.

The above described identification of identification indicators and/or registration of such identifications and/or other automatically registered steps of the treatment process can be stored automatically in the database of the computer system (preferably unalterably in order to increase the reliability of the proof).

The invention further relates to systems for monitoring the treatment of mobile patient support devices which serve for carrying out the above described method. Such a system has at least one computer system with a database, at least one data reader, at least one identification indicator at each mobile patient support device to be monitored, and at least one device to output a notification. The functioning of this system and other embodiments are disclosed in the above description for the method.

In particular, the system in preferred embodiments can additionally comprise at least one further identification indicator at each bed to be monitored which are assigned different infection statuses, at least one further identification indicator in order to record the location of the mobile patient support device, at least one identification indicator on each person involved in the treatment process, identification indicators for the different steps of the treatment process and/or a warning system.

The computer system can be, for example, a single computer with a database which is connected to all the other components, for example, the data reader, notification devices, etc. The computer system can also comprise a server with a database in a common network with a plurality of further computers which themselves are each connected to one or more further components. Thus, for example, a computer can be provided both at each (patient treating) ward as well as at the treatment station, said computer being connected to the server via the network. In this way, the data can be recorded at the individual wards and subsequently transferred from the computers there to the server and stored in the database.

### BRIEF DESCRIPTION OF THE DRAWINGS

The invention will now be described in greater detail making reference to the drawings. In the drawings:

FIG. 1 shows a schematic representation of the processes in the treatment monitoring in a preferred embodiment;

FIG. 2 shows a schematic representation of the processes in the treatment monitoring in a further preferred embodiment; and

FIG. 3 shows a schematic representation of a part of the monitoring of the treatment processes.

### DETAILED DESCRIPTION

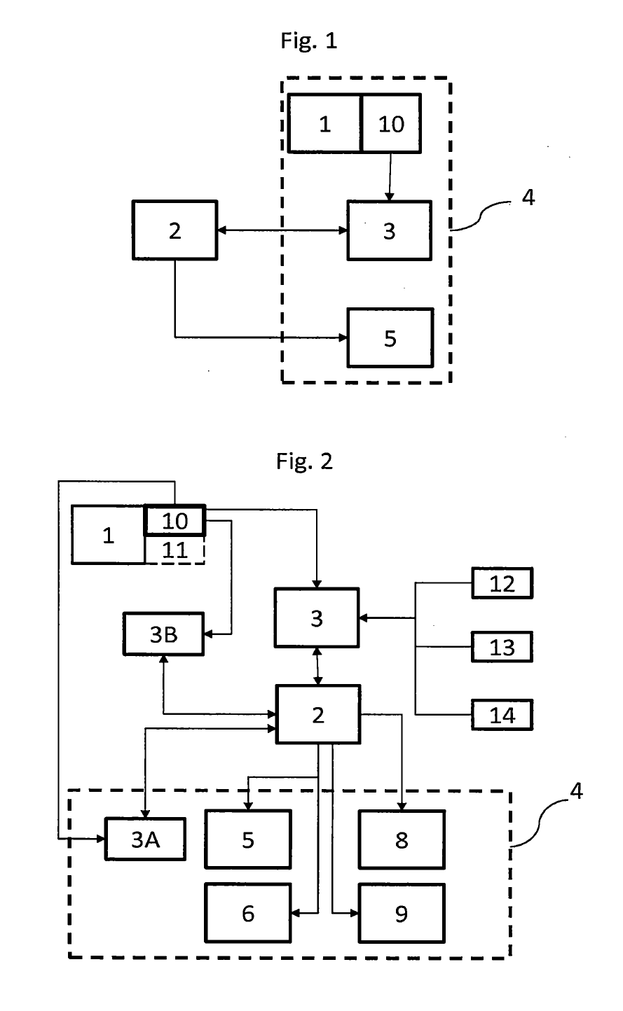

FIG. 1 shows a schematic representation of the monitoring of a mobile patient support device (e.g. a bed) according to a preferred embodiment. The monitoring takes place, for example, according to the following steps. In a first step, based upon an infection status or infection risk of a patient, the infection status of the mobile patient support device (1) is recorded. This takes place, for example, manually in a ward and is entered into a database of a computer system (2). In a next step, the mobile patient support device is collected and relocated into a treatment station (4). Here, in a next step, an identification indicator (10) of the mobile patient support device (1) is identified with a data reader (3) which is connected to the computer system (2). The identification of the identification indicator (10) calls up the infection status of the mobile patient support device (1) from the database of the computer system (2). Then the output of a notification concerning a device (5) regarding the infection status is initiated at the treatment station (4), for example, by means of a warning lamp. This increases, inter alia, the safety of the treatment personnel and ensures a prescribed treatment process.

FIG. 2 shows a schematic representation of the monitoring of a mobile patient support device (e.g. a bed) according to a further preferred embodiment. The monitoring takes place, for example, according to the following steps. In a first step, based upon an infection status or infection risk of a patient, the infection status of the mobile patient support device (1) is recorded. This takes place through an identification of a first identification indicator (10) or a second identification indicator (11) of a mobile patient support device (1) by means of a data reader (3) depending on the infection status or infection risk of the patient. Herein, one of the two identification indicators (10, 11) represents a potential infection risk and the other identification indicator represents an unclean but not infected status. The identification indicators (10, 11) are also configured so that by means of an unambiguous visual recognition of the infection status represented on the identification indicator, they support the acquisition of the infection status. The data reader (3) is in communication with a database in a computer system (2) and, by means of the identification, registers the infection status of the mobile patient support device (1) in the database. In addition, for example, information regarding the location where the patient support device is situated and the person who has acquired the infection status are registered by means of the identification of further identification indicators (12, 13) by means of the data reader (3).

If the acquisition of the infection status has not been undertaken or not correctly, it can further be provided that a manual input or correction in the database of the computer system (2) can only be undertaken by an authorised person.

In a next step, the mobile patient support device (1) is collected by, for example, collection and/or treatment personnel who, by the identification of the identification indicator (10, 11) and/or a further identification indicator (12, 13) can also register/document the process step of the collection with a further data reader (38). An identification of one of the two identification indicators (10, 11) of the mobile patient support device (1) calls up the infection status of the mobile patient support device (1) (regardless of which of the two identification indicators have been identified) and enables a correct processing by the personnel in order to relocate the mobile patient support device (1) safely into the treatment station (4) and to contain the risk of the potential spread of pathogens. The personnel can further be recorded and registered in the database of the computer system (2) through the identification of a further personal identification indicator (14) by means of the data reader (3).

In a next step, one of the identification indicators (10, 11) is identified at the treatment station (4) by means of the data reader (3A) provided there. The infection status of the mobile patient support device (1) is called up (regardless of which of the two identification indicators has been identified) and initiates the output of a notification regarding the infection status by means of a device (5), for example, through a warning lamp. In the event of an infection risk, the notification comprises the output of a safety measure. The safety measure can be, for example, the provision of personal protection equipment and/or the release of means necessary for the treatment by means of the automatic opening of, for example, a further device (6), for example, in the form of a cabinet door. The treatment personnel can put on the personal protection equipment provided and carry out the treatment process only with the released cleaning and disinfecting materials.

In order to ensure a correct and safe progress of the treatment, the individual treatment steps can be registered by identifying identification indicators by means of a data reader and, furthermore, the time elapsed between the registrations can further be compared with a provided target time. If the registrations do not take place in the correct sequence and/or not according to the provided target time, a warning device can automatically output a warning notification. This can be, for example, apart from a warming lamp (8), also a mechanical restriction of a provision via a further warning device (9), for example, the locking of a cabinet door in order to prevent the subsequent steps, or a restriction of the mobility of the mobile patient support device (1), for example, through the effect of a locking, braking or barrier system.

By means of the registration of these treatment steps, it can also be provided that only after a completed treatment process in which all the steps have been registered according to the stored and provided sequence and target times, the infection status of the mobile patient support device (1) is adjusted and a new status of the mobile patient support device (1) can be recorded as “treated” or “available”.

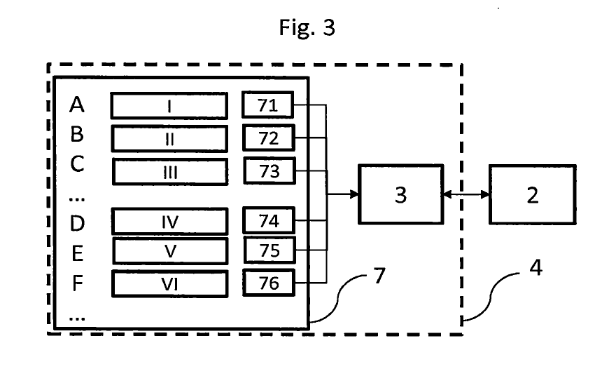

FIG. 3 shows a schematic representation of a preferred embodiment of the monitoring of the treatment processes. Herein, for example, different steps (A-F) of the treatment process listed on a wall chart (7) are provided alongside a process description (I-VI), also with the identification indicators (71-76). The different treatment processes can be registered in the database of a computer system (2) by means of a data reader (3) in that the corresponding identification indicators (71-76) can be identified at the treatment station (4) with the data reader (3). The data reader (3) is also in communication with a computer system having a database. The registrations can further, according to FIG. 2, cause one or more warning devices (8, 9) to output a warning notification, in order to correct possible erroneous steps and to ensure the safety of the treatment.

### REFERENCE SIGNS

1 Mobile patient support device

10 Indicator of the mobile patient support device

11 Further indicator of the mobile patient support device

12 Indicator of location

13 Personal indicator

14 Further personal indicator or personnel treatment

2 Computer system with a database

3 Data reader

3A Further data reader

3B Further data reader for collection and delivery service

4 Treatment station

5 Device for output of a notification

6 Further device for output of a notification

7 Wall chart

71 Identification indicator process step A

72 Identification indicator process step B

73 Identification indicator process step C

74 Identification indicator process step D

75 Identification indicator process step E

76 Identification indicator process step F

8 Warning light

9 Warning device

1. Method for monitoring the treatment of mobile patient support devices, comprising the steps:
recording the infection status of a mobile patient support device in a database of a computer system;
identification of the mobile patient support device at a treatment station through the identification, with a data reader, of an identification indicator applied to the mobile patient support device;
output of a notification concerning the infection status of the mobile patient support device at the treatment station.

2. Method according to claim 1, wherein the infection status is recorded in the computer system with a data reader which identifies an identification indicator applied to the mobile patient support device.

3. Method according to claim 2, wherein the mobile patient support device comprises at least two identification indicators which are assigned to different infection statuses, and wherein the data reader identifies one of the at least two identification indicators.

4. Method according to claim 3, wherein the identification indicators are configured also to indicate the infection status visually.

5. Method according to claim 1, wherein the identification of the identification indicator takes place by means of radio and/or optically.

6. Method according to claim 1, further comprising the step:
recording the location of the mobile patient support device in the database.

7. Method according to claim 6, wherein recording the location is undertaken by identification, with a data reader, of a further identification indicator applied at the site or close to the site.

8. Method according to claim 1, further comprising the step:
recording in the database of the person involved for the treatment process by identifying a personal identification indicator with a data reader.

9. Method according to claim 1, wherein the notification can comprise an acoustic, visual, audiovisual and/or mechanical signal and/or generates a data set on the data reader.

10. Method according to claim 1, wherein the output of the notification regarding the infection status comprises the provision of at least one safety measure and/or the restriction of the mobility of the mobile patient support device.

11. Method according to claim 1, wherein the treatment process comprises successive steps wherein the execution of the steps is registered with a data reader.

12. Method according to claim 11, wherein the passage of time of the steps of the treatment process is monitored and a notification is output at least at a predetermined time during at least one of the steps of the treatment process.

13. Method according to claim 11, wherein following the registration of a step of the treatment process, a timer is started, wherein upon a registration of a further step of the treatment process before the expiry of the timer, a warning system is caused to output a warning notification.

14. Method according to claim 11, wherein upon a registration of the steps of the treatment process in a sequence which deviates from a pre-determined sequence, a warning system is caused to output a warning notification.

15. Method according to claim 13, wherein the warning notification comprises a restriction or release of the provision of a safety measure or a restriction of the mobility of the mobile patient support device.

16. System for monitoring the treatment of mobile patient support devices, comprising:
a) a computer system with a database;
b) at least one data reader;
c) at least one identification indicator at each mobile patient support device to be monitored;
d) at least one device to output a notification;
wherein the system is configured to record the infection status of a mobile patient support device in the database of the computer system, to identify the mobile patient support device at a treatment station through identification, with a data reader, of an identification indicator applied to the mobile patient support device and to output a notification regarding the infection status of the mobile patient support device at the treatment station.

17. System according to claim 16, wherein the system is further configured to record the infection status of a mobile patient support device in a database of a computer system by means of a data reader.

18. System according to claim 17, wherein the system comprises at least two identification indicators on each bed to be monitored, said infection indicators being assigned to different infection status levels and wherein the system is configured to identify an identification indicator by means of a data reader.

19. System according to claim 18, wherein the at least two identification indicators applied to a mobile patient support device are configured also to indicate the infection status visually.

20. System according to claim 16, wherein the system is also configured to identify the identification indicator by means of radio and/or optically.

21. System according to claim 16, wherein the system is further configured to record the location of the mobile patient support device in the database.

22. System according to claim 21, further comprising at least one identification indicator at each location to be recorded or in the vicinity of each of the locations to be recorded, wherein the system is also configured to record the location of the mobile patient support device by identifying an identification indicator applied at the location or in the vicinity of the location with a data reader.

23. System according to claim 16, further comprising at least one personal identification indicator, wherein the system is further configured to record the person participating in the treatment process in the database by identifying a personal identification indicator with a data reader.

24. System according to claim 16, wherein the device to output a notification is configured to have an acoustic, visual, audiovisual and/or mechanical signal and/or to generate a data set on the data reader.

25. System according to claim 16, wherein the device to output a notification comprises provision means for providing at least one safety measure.

26. System according to claim 16, wherein the system is also configured to register the execution of the successive steps of the treatment process with a data reader.

27. System according to claim 26, wherein the system is further configured to monitor the passage of time of the steps of the treatment process, wherein at least at a predetermined time, a notification is output.

28. System according to claim 26, wherein the system is further configured in order, following the registration of a step of the treatment process, to start a timer, wherein upon a registration of a further step of the treatment process before the expiry of the timer, a warning system is caused to output a warning notification.

29. System according to claim 26, further comprising a warning system, wherein the system is further configured in order, upon a registration of the steps of the treatment process in a sequence which deviates from a pre-determined sequence, to cause the warning system to output a warning notification.

30. System according to claim 28, wherein the system is further configured to output a warning notification which comprises a restriction or release of the provision of a safety measure or a restriction of the mobility of the mobile patient support device.
